(19) United States
(12) Patent Application Publication
(10) Pub. No.: US 2014/0254800 A1
(43) Pub. Date: Sep. 11, 2014

(54) High-Security Outdoor Wireless Communications Bridge

(71) Applicant: AvaLAN Wireless Systems, Inc., Madison, AL (US)

(72) Inventor: Michael R. Derby, Madison, AL (US)

(73) Assignee: AvaLAN Wireless Systems, Inc., Madison, AL (US)

(21) Appl. No.: 14/285,268

(22) Filed: May 22, 2014

Related U.S. Application Data
(63) Continuation-in-part of application No. 13/608,647, filed on Sep. 10, 2012.
(60) Provisional application No. 61/532,194, filed on Sep. 8, 2011.

(51) Int. Cl. H04L 29/06; H04W 12/08

(52) U.S. Cl. CPC H04L 63/0428; H04W 12/08
USPC 380/270

(57) ABSTRACT

An appliance for transmitting and receiving encrypted wireless network signals, preferably, in a 900 MHz band, includes a radio frequency module, coupled to a cryptographic module, which, in turn is coupled to an Ethernet interface module and a power-over-Ethernet splitter. The components are affixed to a thermally conductive substrate that is mounted to the floor of a chamber defined by a thermally conductive housing.

### CROSS-REFERENCE TO RELATED APPLICATIONS

This application is a continuation-in-part of U.S. application Ser. No. 13/608,647, filed Sep. 10, 2012, which claims priority of U.S. Provisional App. Ser. No. 61/532,194 filed Sep. 8, 2011.

### BACKGROUND

1. Field

The present application is directed to a system that relates generally to network communications, and, in particular to wireless network communications, and in particular to wireless communications using an outdoor antenna powered by a “power-over-Ethernet” configuration with encryption.

2. Description of the Problem and Related Art

Outdoor wireless data transmission is limited by several factors including range, power, and signal line loss between the antenna and the transceiver. Many state-of-the-art solutions to increase network coverage area is to install “bridge” radios that allow two or more networks to communicate with one another. The 900 MHz frequency band exhibits desirable characteristics for this application. With sufficient gain, a 900 MHz radio can provide communications at ranges comparable to that exhibited by lower frequencies. However, with increased gain comes an increased need to dissipate heat to prevent damage to sensitive electronic components. For example, a 900 MHz radio operated at about 1 Watt requires the need to dissipate a roughly 5 Watt thermal load.

Consequently, a radio is desired suitable to operate in the 900 MHz band, with an increased range, operating at about a gain of 1 Watt and adapted to dissipate the resulting thermal load. In addition, it is desirable to have data encryption to enable high-security data transmission. In conventional outdoor wireless networking systems (See FIG. 6) the transceiver, and in particular, any encryption components, are located at some distance from the antenna which is mounted high to maximize line-of-sight range of the signal. This arrangement is done to allow convenient management of encryption key data and to protect the radio system. For network communications, an Ethernet interface is needed to convert the radio signal to an Ethernet protocol for local network use. However, such an arrangement results in a significant line loss of the signal from the antenna to the radio. Accordingly, it is further desired to minimize signal loss cause by line distance between the transceiver, the antenna and the encryption/decryption components.

### DESCRIPTION OF THE INVENTION

### BRIEF DESCRIPTION OF THE DRAWINGS

The present invention is described with reference to the accompanying drawings. In the drawings, like reference numbers indicate identical or functionally similar elements. Additionally, the left-most digit(s) of a reference number identifies the drawing in which the reference number first appears.

FIG. 1 is illustrates an exemplary high-security outdoor wireless network bridge appliance;

FIG. 2 is another view of the exemplary bridge appliance of FIG. 1;

FIG. 3 is a functional block diagram of the exemplary bridge appliance;

FIG. 4 is a functional block diagram of an exemplary encryption/decryption module; and

FIG. 5A is a top plan view of an exemplary encryption module;

FIG. 5B is a section view of the exemplary encryption module as indicated; and

FIG. 6 is an illustration of a prior art arrangement of outdoor wireless radios.

### DETAILED DESCRIPTION

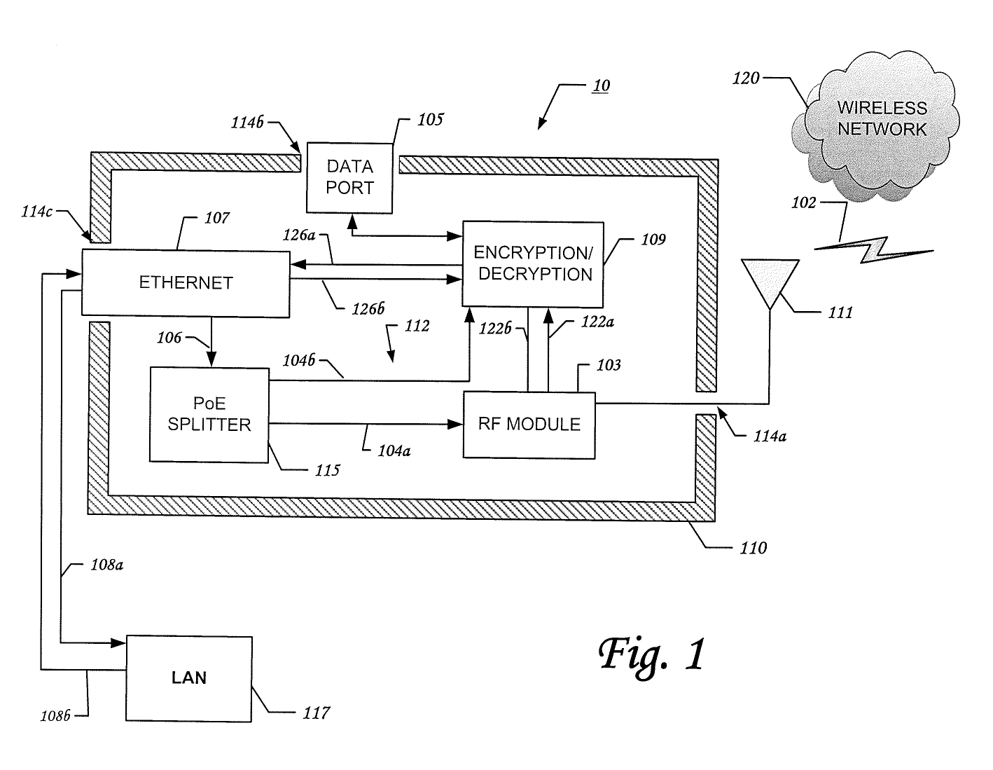

The various embodiments of the present invention and their advantages are best understood by referring to FIGS. 1 through 4 of the drawings. The elements of the drawings are not necessarily to scale, emphasis instead being placed upon clearly illustrating the principles of the invention. Throughout the drawings, like numerals are used for like and corresponding parts of the various drawings.

This invention may be provided in other specific forms and embodiments without departing from the essential characteristics as described herein. The embodiments described herein are to be considered in all aspects as illustrative only and not restrictive in any manner. The appended claims rather than the following description indicate the scope of the invention.

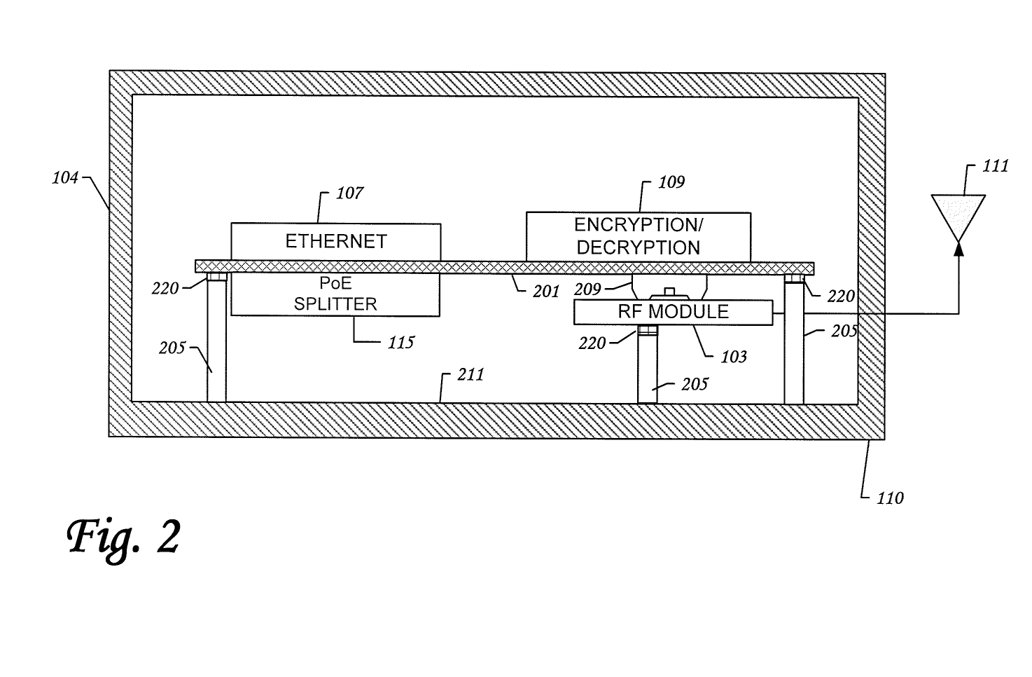

FIGS. 1 and 2 illustrate the main components of an exemplary high-security outdoor bridge 10 comprising a housing 110 which comprises a material having a relatively high degree of thermal conductivity, e.g., a metal, and preferably cast aluminum and which defines a chamber 112. An antenna 111 extends from an exterior side of the housing 110 and is suitable for coupling encrypted radio frequency signals 102 from a wireless network to a radio frequency (RF) module 103 that is within the housing 110 through an aperture 114a in the housing 110 wall. The RF module 103 is in coupled to a cryptographic module 109 which is, in turn, coupled to an Ethernet interface module 107. An external data port 105 is coupled to the encryption/decryption module 109 and extends through an aperture 114b defined in a wall of the housing 110. Similarly, the Ethernet interface module 107 includes data connection that extends through an aperture 114c in a wall of the housing. Apertures 114a, b, and c, are sealed around any conductors or ports that extend therethrough in order to prevent precipitation or other foreign matter from entering the chamber 112, creating a weather-resistant enclosure 112. A splitter 115 is also enclosed in the housing 110 and is coupled to the Ethernet interface module 107. The splitter 115 diverts a power signal 106 from an incoming Ethernet signal 106 and relays the power signal 104a, b to energize the components of the exemplary wireless bridge 10.

FIG. 2 depicts an exemplary arrangement of the components within the housing 110 from a side sectional view where a substrate 201 formed from a thermally conductive material is mounted above the floor 211 of the housing 110 upon a plurality of thermally conductive support interfaces 205 such that a space is created between the substrate 201 and the housing floor 211. In this arrangement, the cryptographic module 109 and the Ethernet interface module 107 mounted to the upper surface of the substrate 201. In this example, the RF module 103 and the splitter 115 are located underneath the substrate 201 attached to its under surface. RF module 103 may be coupled with a header member 209 extending from the under surface of the substrate 201 and supported by a support member 205 attached to the housing floor 211. Support members 205 are affixed to each of the substrate 201 and the RF module 103 using a thermally conductive adhesive 220.

In operation, an encrypted wireless signal 102 is coupled to the antenna 111 from a wireless network 120. RF module 103 is responsive to the antenna 111, and receives and demodulates the received encrypted signal 102. A demodulated encrypted signal 122a is output by the RF module 103 and received as input by the encryption/decryption module 103 which decrypts the signal 122a and outputs a decrypted signal 126 that is received by the Ethernet interface module 107 for relaying to a local network 117 as an Ethernet data signal 108a.

Contrariwise, an outgoing Ethernet data signal 108b is received from the LAN 117 by the Ethernet interface module 107 which relays an outgoing unencrypted data signal 126b to the cryptographic module 109. Concurrently, a power signal 106 is diverted from the Ethernet signal 108b by the splitter 115 which outputs power signals 104a, b to the powered components. The cryptographic module 109 encrypts the unencrypted data signal 126b and outputs an encrypted signal 122b which is received by the RF module 103. The RF module 103 modulates the encrypted data signal 126b and couples a modulated encrypted signal 102b to the antenna 111.

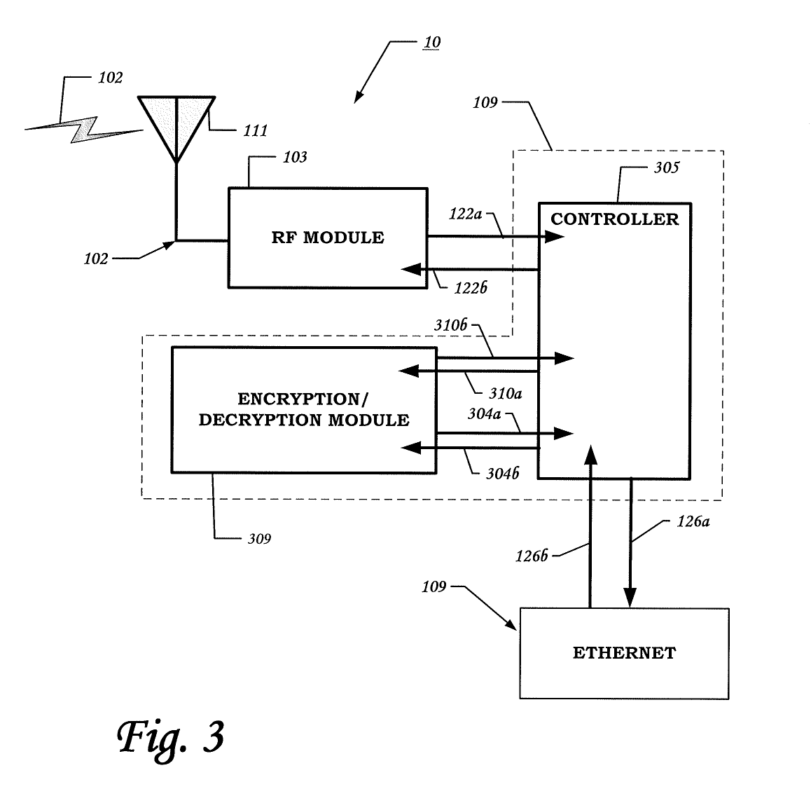

Referring now to FIG. 3, the exemplary wireless bridge 10 comprises an RF module 103 which may be modulating and demodulating transceiver. It will be appreciated that both antenna 111 and RF module 103 are suitable for operation over the entire spectrum of wireless radio frequencies, whether narrowband, broadband, wideband, or ultra wideband, and using a any spread spectrum coding techniques including without limitation time-division multiplexing (TDMA), code division multiplexing (CDMA), and direct sequence spread spectrum (DSSS) and the like. However, the configuration described herein is particularly suited for networks operating over a frequency of 900 MHz.

As described above, antenna 111 couples data signals 102 from a wireless network 120 to the RF module 103 which is coupled to the cryptographic module 109 that is comprised of a data flow controller 305, and an encryption/decryption module 309. The data flow controller 305 is also coupled to the Ethernet interface module 107.

As can also be appreciated from the figure, the exemplary data flow controller 305 is configured with a number of inputs and outputs to accommodate the various data signals as would be understood by those skilled in the relevant art. For example, an incoming wireless data signal 102 from the unsecured wireless network 120 is coupled to the antenna 111 and conducted to the RF module 103. The data signal 102 in this example is encrypted. The RF module 103 demodulates the signal and outputs an encrypted data signal 122a that is received as input by the data flow controller 305. The data flow controller 305 is a computer-based processor (described below) configured to convey the encrypted data signal 122a to be received as input 310a by the encryption/decryption component 309. The encryption/ decryption module 309 is also a computer-based processor, and is configured to decrypt the encrypted signal 310a and output a decrypted signal 304a that is received as input by the controller 305, which in turn, outputs an unencrypted data signal 126a.

Conversely, the Ethernet interface module 109 may receive an outbound unencrypted data signal from the local network and relay an unencrypted outbound signal 126b to the data controller 305 to be input 304b to the encryption/decryption module 409, which outputs an outbound encrypted signal 310b. The outbound encrypted signal 310b is then conducted by the controller 305 to the RF module 103 as an outbound encrypted, un-modulated data signal 122b, and the RF module 103 then modulates the data signal 122b for coupling to the network 120 as an encrypted wireless network data signal 102.

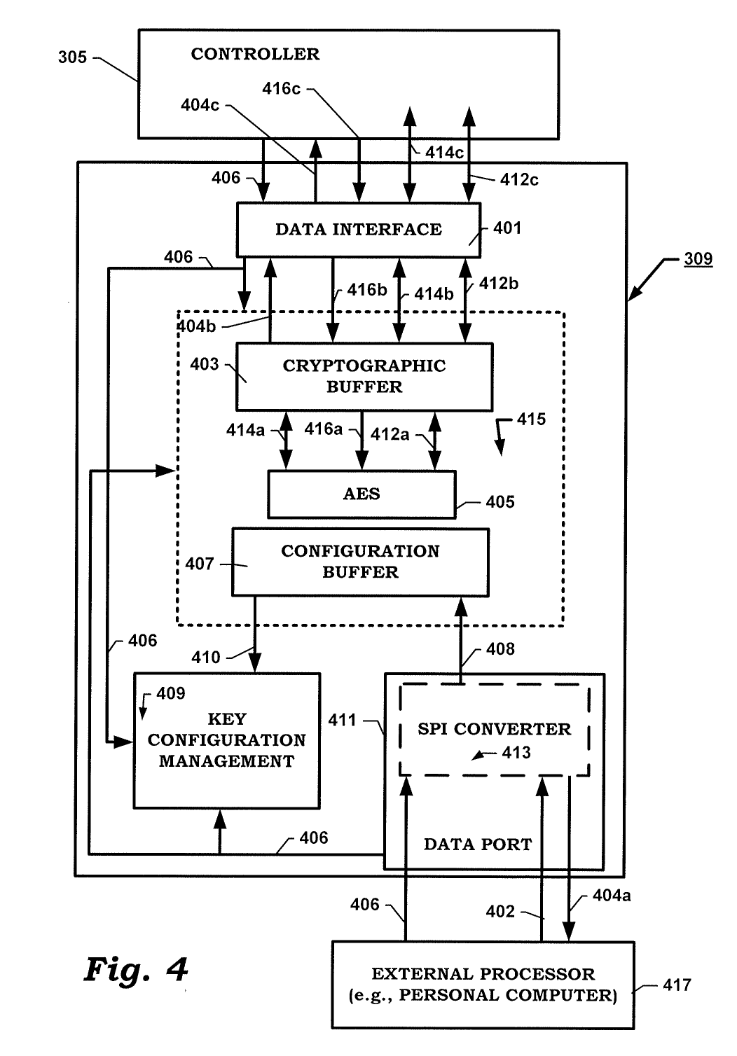

FIG. 4 provides a more detailed illustration of an exemplary encryption/decryption module 309 comprising a data interface 401, which is preferably a serial peripheral interface (“SPI”) suitable for coupling the module 309 to the data flow controller 305. The module 309 may advantageously be achieved with a processor 415 comprising a buffer 403 for encrypted and decrypted data, a configuration buffer 407 for buffering encryption key data, and an encryption processor 405, which is preferably configured to encrypt or decrypt pursuant to the Advanced Encryption Standard (“AES”) or follow-on standards.

The module further comprises a key configuration management component 409 and a data port 411 for enabling external management of encryption key data from an external processor device 417. The data port may be, for example a universal serial bus (USB), and includes converter apparatuses 413, as required, for converting data from USB format to SPI data, as would be understood by those skilled in the art. Alternatively, a universal asynchronous receiver/transmitter (“UART”) converter may be needed to translate data signals between serial and parallel formats depending upon the configuration of the data port 411. Module 309 may be implemented with one or more processors, and may be a “multi-chip module” (“MCM”).

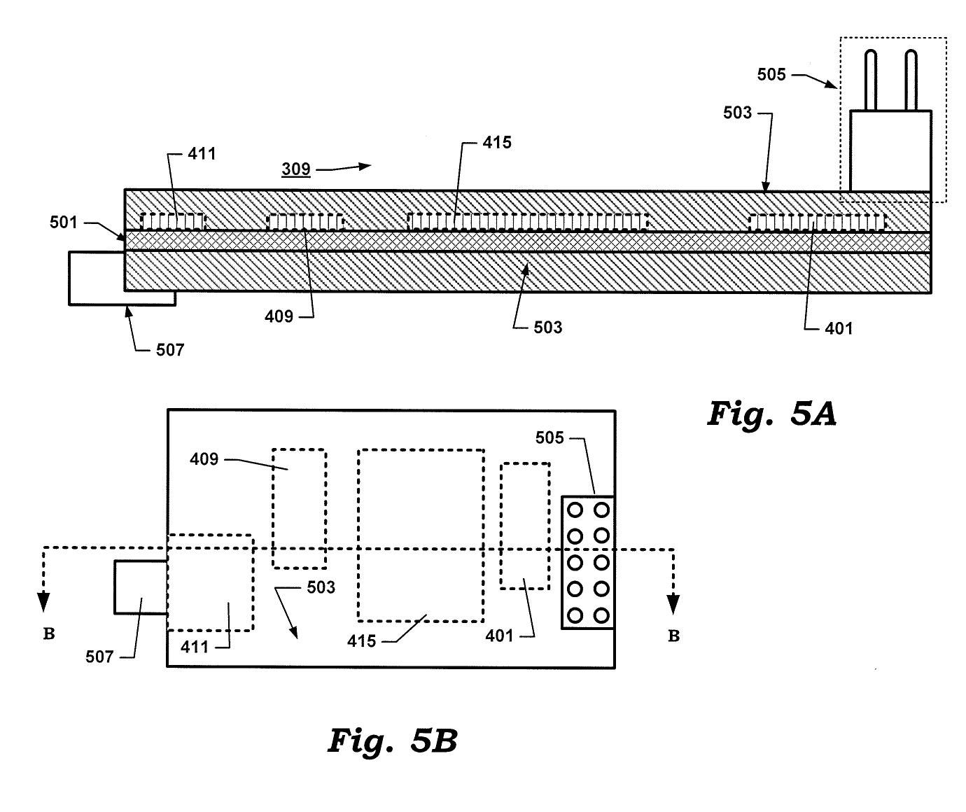

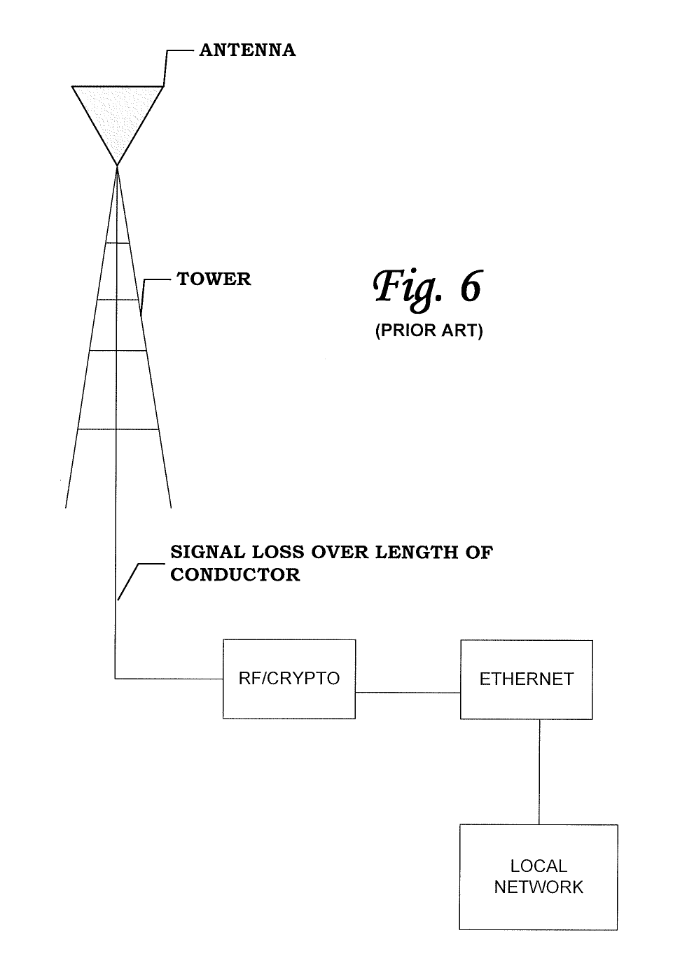

Module 309 is preferably adapted to meet U.S. Government Federal Information Processing Standards (“FIPS”) Pub. 140-2 Level II encryption standards, promulgated by the National Institute of Standards and Technology, which requires validated encryption devices to not only be resistant to unauthorized tampering, but also to be able to indicate when such tampering as occurred. To this end, and with reference to FIGS. 5A, 5B, an illustration of the module 309 comprising a circuit board 501 on which is disposed the data interface 401, the processor 415, the encryption key configuration management component 409 and data port 411. In addition, this illustration shows the SPI data pins 505, and a data port jack 507 that enables physical connection of the data port 411 to an external device (FIG. 4: 417). Encasing the board 501 and the components 401, 415, 409, 411, are two layers of potting 503. The potting 503 layers will evidence attempts to tamper with the processors because the potting will need to be removed in order to gain access.

Data flow through the module is illustrated in FIG. 4 as well where encrypted data signals 414c are coupled between the controller 305 and the data interface 401. Additionally, the controller also transmits power and control signals (406b and 416c, respectively) to the module through the interface 401. The data interface 401 relays the encrypted data signal 414b, control signal 416b and a power signal 406b to the processor 415, where the encryption and control signals 414b, 416b and are received by the cryptographic buffer 403 and which transfers them 414a, 416a to the encryption processor 405 for decryption. Decrypted signals 412a-c are conducted in reverse from the encryption processor 405 to the buffer 403, thence to the data interface 401, and to the controller 305, and in response to control signals 416a-c issued by the controller 305.

Meanwhile, encryption key management is enabled using an external processor 417 through the data port 411 with key data input signal 402 that may be translated into the appropriate data form by converter(s) 413, and conveyed 408 to the key configuration data buffer 407. Buffer 407 communicates key data 410 to the key configuration management component 409, which stores and coordinates encryption key data. Power signals 406 are also relayed through the data port 411 to the indicated components on the key configuration portion of the module 409.

As described above, many of the system's components may be achieved with the use of a computer-based processor. Accordingly, the detailed description that follows is presented largely in terms of processes and symbolic representations of operations performed by computer-based processors. A computer-based processor may be any microprocessor or processor (hereinafter referred to as processor) controlled device, such as, by way of example, personal computers, workstations, servers, clients, mini-computers, main-frame computers, laptop computers, a network of one or more computers, mobile computers, portable computers, handheld computers, palm top computers, personal digital assistants, interactive wireless devices, or any combination thereof. For example, a processor may also be implemented by a field programmable gated array (FPGA), an integrated circuit, an application specific integrated chip (ASIC), a central processing unit (CPU) with a memory or other logic device. The processor may possess input devices such as, by way of example, a keyboard, a keypad, a mouse, a microphone, or a touch screen, and output devices such as a processor screen, printer, or a speaker.

The processor may be a uniprocessor or multiprocessor machine. Additionally, the processor includes memory such as a memory storage device or an addressable storage medium. The memory storage device and addressable storage medium may be in forms such as, by way of example, a random access memory (RAM), a static random access memory (SRAM), a dynamic random access memory (DRAM), an electronically erasable programmable read-only memory (EEPROM), a programmable read-only memory (PROM), an erasable programmable read-only memory (EPROM), hard disks, floppy disks, laser disk players, digital video disks, compact disks, video tapes, audio tapes, magnetic recording tracks, electronic networks, and other devices or technologies to transmit or store electronic content such as programs and data.

The processor executes an appropriate operating system such as Linux, Unix, Microsoft® Windows® 95, Microsoft® Windows® 98, Microsoft® Windows® NT, Apple® MacOS®, IBM® OS/2®, and the like. The processor may advantageously be equipped with a network communication device such as a network interface card, a modem, or other network connection device suitable for connecting to one or more networks.

The processor, and the processor memory, may advantageously contain control logic or other substrate configuration representing data and instructions, which cause the processor to operate in a specific and predefined manner as, described herein. The control logic may advantageously be implemented as one or more modules. The modules may advantageously be configured to reside on the processor memory and execute on the one or more processors. The modules include, but are not limited to, software or hardware components that perform certain tasks. Thus, a module may include, by way of example, components, such as, software components, processes, functions, subroutines, procedures, attributes, class components, task components, object-oriented software components, segments of program code, drivers, firmware, micro-code, circuitry, data, and the like.

The control logic conventionally includes the manipulation of data bits by the processor and the maintenance of these bits within data structures resident in one or more of the memory storage devices. Such data structures impose a physical organization upon the collection of data bits stored within processor memory and represent specific electrical or magnetic elements. These symbolic representations are the means used by those skilled in the art to effectively convey teachings and discoveries to others skilled in the art.

The control logic is generally considered to be a sequence of processor-executed steps. These steps generally require manipulations of physical quantities. Usually, although not necessarily, these quantities take the form of electrical, magnetic, or optical signals capable of being stored, transferred, combined, compared, or otherwise manipulated. It is conventional for those skilled in the art to refer to these signals as bits, values, elements, symbols, characters, text, terms, numbers, records, files, or the like. It should be kept in mind, however, that these and some other terms should be associated with appropriate physical quantities for processor operations, and that these terms are merely conventional labels applied to physical quantities that exist within and during operation of the computer.

It should be understood that manipulations within the processor are often referred to in terms of adding, comparing, moving, searching, or the like, which are often associated with manual operations performed by a human operator. It is to be understood that no involvement of the human operator may be necessary, or even desirable. The operations described herein are machine operations performed in conjunction with the human operator or user that interacts with the processor or computers.

It should also be understood that the programs, modules, processes, methods, and the like, described herein are but an exemplary implementation and are not related, or limited, to any particular processor, apparatus, or processor language. Rather, various types of general purpose computing machines or devices may be used with programs constructed in accordance with the teachings described herein. Similarly, it may prove advantageous to construct a specialized apparatus to perform the method steps described herein by way of dedicated processor systems with hard-wired logic or programs stored in nonvolatile memory, such as, by way of example, read-only memory (ROM), for example, components such as application specific integrated circuits (ASICs) or field-programmable gated arrays (FPGAs). Implementation of the hardware state machine so as to perform the functions described herein will be apparent to persons skilled in the relevant art(s). In an embodiment where the invention is implemented using software, the software can be stored in a computer program product and loaded into the computer system using the removable storage drive, the memory chips or the communications interface. The control logic (software), when executed by a control processor, causes the control processor to perform certain functions of the invention as described herein.

As described above and shown in the associated drawings, the present invention comprises system for enabling a virtual private network over an unsecured network. While particular embodiments of the invention have been described, it will be understood, however, that the invention is not limited thereto, since modifications may be made by those skilled in the art, particularly in light of the foregoing teachings. It is, therefore, contemplated by the appended claims to cover any such modifications that incorporate those features or those improvements that embody the spirit and scope of the present invention.

I claim:

1. An apparatus for enabling encrypted communication between a local area network and a wireless unsecured network, said wireless unsecured network consisting of signals modulated at a frequency of about 900 MHz, said apparatus comprising:
a transceiver coupled to an antenna via a conductor and configured to receive and demodulate an encrypted wireless network data signal from said wireless unsecured network and output an encrypted data signal;
a cryptographic module having an input and an output, and configured to receive said encrypted data signal and convert said encrypted data signal to a decrypted signal;
an Ethernet interface module coupled to said decrypted signal, and coupled to a local computer network and configured to output an Ethernet data signal to said local computer network and to receive outbound Ethernet data signal from said computer network;
a splitter for diverting a power signal from said outbound Ethernet data signal and conducting said power signal to said transceiver, and said cryptographic module; and
a housing defining an interior chamber in which is housed said transceiver, cryptographic module, Ethernet interface module and splitter, said housing having an aperture defined within a wall of said housing extending from said chamber through which said conductor extends to an exterior of said housing.

2. The apparatus of claim 2, wherein said cryptographic module further comprises an external input/output port for management of cryptographic data.

3. The apparatus of claim 3, where said cryptographic module is encased potting suitable to indicate attempted tampering with said cryptographic module.

4. The apparatus of claim 1, wherein said transceiver, said cryptographic module, said Ethernet interface module and said splitter are mounted within said chamber to a thermally conductive substrate which is mounted to a floor of said chamber upon plurality of thermally conductive support members.

5. The apparatus of claim 5, wherein said housing comprises a thermally conductive material.

6. The apparatus of claim 7, wherein said cryptographic module further comprises an external input/output port for enabling management of cryptographic data.

7. The apparatus of claim 8, where said cryptographic module is encased potting suitable to indicate attempted tampering with said cryptographic module.

8. A computer-based system for enabling encrypted transmission between a local network and a unsecured wireless network, said apparatus comprising:
a computer-based appliance enclosed in a thermally conductive housing and comprising:
a radio frequency module configured to de-modulate encrypted radio frequency data signals received from said wireless network; and
a cryptographic module responsive to said radio frequency module; and
an Ethernet interface module coupled to a power-over-Ethernet splitter;
a local network coupled to said appliance; and
wherein said cryptographic module is configured with pre-defined encryption data; and
wherein said cryptographic module is configured with control logic that causes said module to:
decrypt encrypted radio frequency data signals received from radio frequency module; and
encrypt un-encrypted data signals received from said local network.

9. The system of claim 10, wherein said appliance comprises an antenna suitable to couple wireless data signals received from said unsecured public network to said modem.

10. The system of claim 11, wherein said cryptographic module further comprises an external input/output port for management of cryptographic data.

11. The system of claim 10, where said cryptographic module is encased potting suitable to indicate attempted tampering with said cryptographic module.

12. The system of claim 11, further comprising:
a chamber defined by said housing;
thermally conductive substrate mounted to said floor of said chamber upon a plurality of thermally conductive support members; and
wherein said radio frequency module, said cryptographic module, said Ethernet interface module and said splitter are affixed to said substrate above said floor.

13. The system of claim 12, further comprising weather-resistant apertures defined within one or more walls of said housing through which a plurality of signals are conveyed, said signals being at least one of received wireless network signals, transmitted wireless network signals, Ethernet data signals and cryptographic management data signals.
